(19) United States
(12) Patent Application Publication
(10) Pub. No.: US 2014/0229254 A1
(43) Pub. Date: Aug. 14, 2014

(54) Method of Target Advertising

(71) Applicants: Alexandre Dammous, Clearwater, FL (US); Renaud Migeot, Noville Les Bois (BE)

(72) Inventors: Alexandre Dammous, Clearwater, FL (US); Renaud Migeot, Noville Les Bois (BE)

(21) Appl. No.: 13/766,957

(22) Filed: Feb. 14, 2013

(51) Int. Cl. G06Q 30/02

(52) U.S. Cl. CPC G06Q 30/0251
USPC 705/14.19

(57) ABSTRACT

A method of target advertising comprises creating an advertisement, selecting a target audience, selecting a per-feedback reward, selecting a budget, sending the advertisement to members of the target audience, receiving feedback from a subset of the members, paying a reward to the subset based at least in part on the per-feedback reward, and repeating steps until reaching the budget.

### BACKGROUND OF THE INVENTION

The present invention relates to a platform that pays willingly participating smartphone users to view and rate advertisements.

Problems with existing solutions include: Advertisers spend a lot of money on campaigns that are not targeted, or only vaguely targeted by the use of internet consumer profile builders, that are often inaccurate. The advertiser pays in advance for a promotion or a campaign, but doesn't get the chance to change it while it runs, to adapt it, to expand its scope or to diminish it. The advertiser has to wait until the campaign is over to obtain only vague data on its success. Receivers of ads have no control on the profile used to select them for certain ads or promotions. Receivers of ads are swamped, spammed and polluted by advertisement in paper, airwave time, and on the internet, with very little means to control the influx. The receiver of ads is a passive actor.

Other advertisement processes do not offer interactivity with both the receiver of the ad, a real time feedback, and do not allow the advertiser to change the campaign while it is running in order to maximize its impact and profitability.

As can be seen, there is a need for solutions to these and other problems.

### SUMMARY OF THE INVENTION

In one aspect of the present invention, a method of target advertising comprises: a) creating an advertisement; b) selecting a target audience; c) selecting a per-feedback reward; d) selecting a budget; e) sending the advertisement to members of the target audience; f) receiving feedback from a subset of the members; g) paying a reward to the subset based at least in part on the per-feedback reward; and h) repeating steps e)-g) until reaching the budget.

In one aspect, step e) comprises sending the advertisement to the members of the target audience via a wireless connection to mobile devices. In one aspect, step b) comprises selecting the target audience according to at least one of demographics, geographic location, and indicated interests. In one aspect, the feedback comprises at least one of a comment, a rating, and a purchase. In one aspect, step g) comprises paying the reward to the subset in the form of cards redeemable for at least one of goods, services, and cash.

In one aspect, the method further comprises tracking an advertisement campaign through an advertisement campaign analysis. In one aspect, the analysis comprises at least two of: a real-time feedback disclosure, a penetration rate, comparison of a current campaign to a prior campaign, and a conversion rate.

In one aspect, the method further comprises identifying abuse by abusive members of the target audience. In one aspect, the step of identifying abuse depends on at least one of: duplicate names, duplicate addresses, systematic opening of all advertisements received, and systematic identical rating of advertisements received.

In one aspect, a method of target advertising comprises: a) entering user information into a server; b) providing a mobile device; c) indicating a willingness to receive advertisements via the mobile device; d) receiving advertisements wirelessly via the mobile device, the advertisements selected at least in part on the user information; e) viewing the advertisements; f) providing feedback regarding the advertisements; and g) receiving a reward for providing the feedback.

In one aspect, the method further comprises sending at least one of the advertisements to others. In one aspect, the method further comprises changing the user information after viewing the advertisements. In one aspect, the method further comprises selecting a list of preferred rewards for providing feedback.

In one aspect, the user information comprises at least one of demographics, geographic location, and indicated interests. In one aspect, the feedback comprises at least one of a comment, a rating, and a purchase. In one aspect, step g) comprises receiving the reward in the form of a card redeemable for at least one of goods, services, and cash. In one aspect, step g) comprises receiving the reward for providing the feedback only when a predetermined threshold has been reached.

These and other features, aspects and advantages of the present invention will become better understood with reference to the following drawings, description and claims.

### BRIEF DESCRIPTION OF THE DRAWINGS

FIG. 1: is a schematic overview of one embodiment of the invention.

FIG. 2: is a flowchart of one embodiment of the invention.

FIG. 3: is a continuation of FIG. 2.

FIG. 4: is a main process flowchart of one embodiment of the invention.

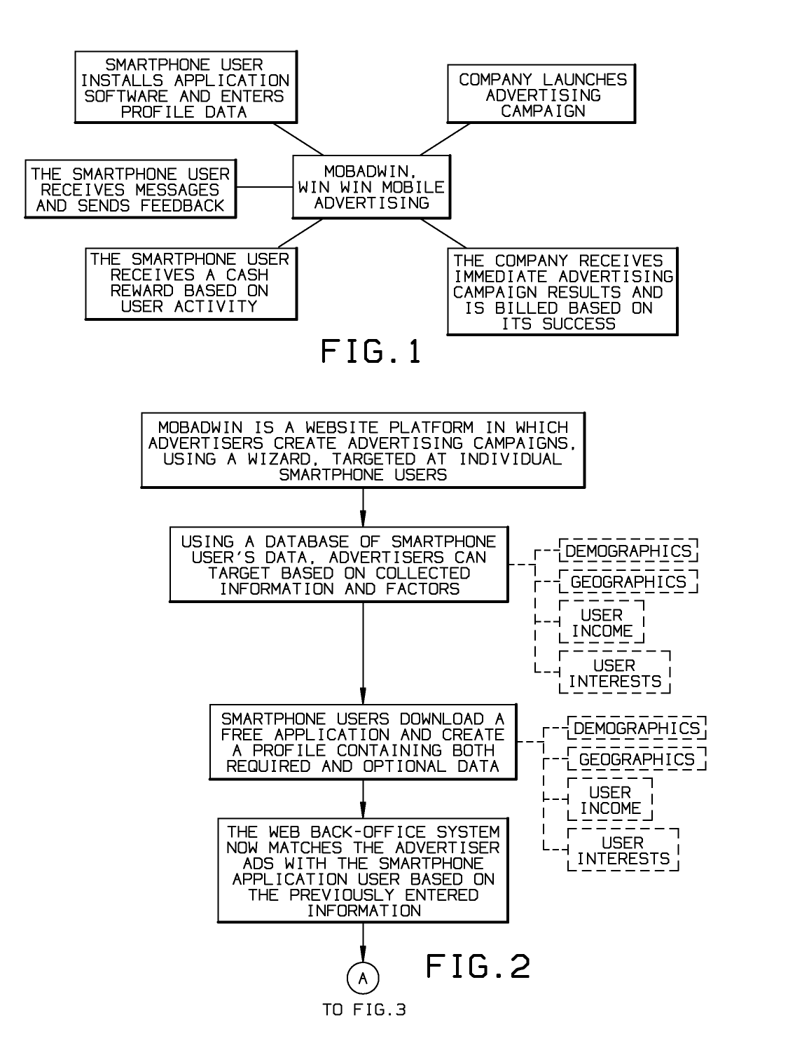

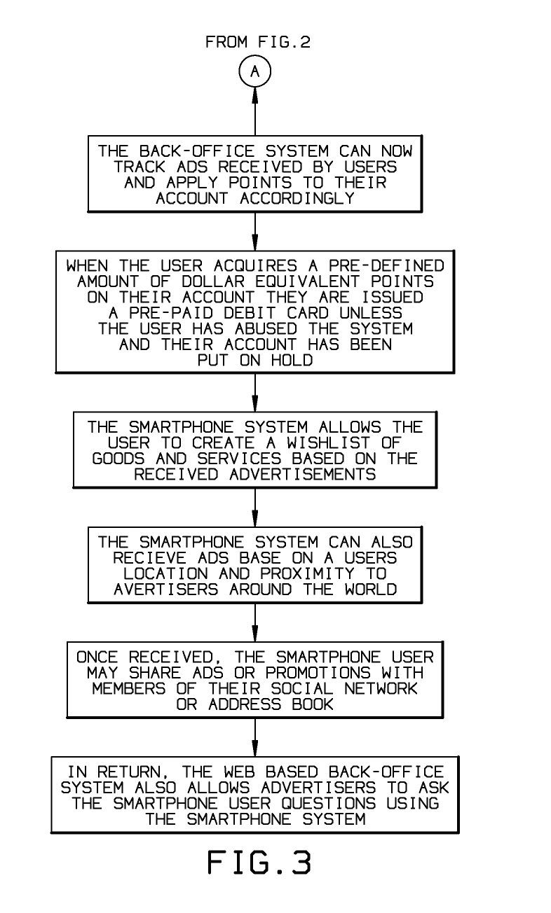

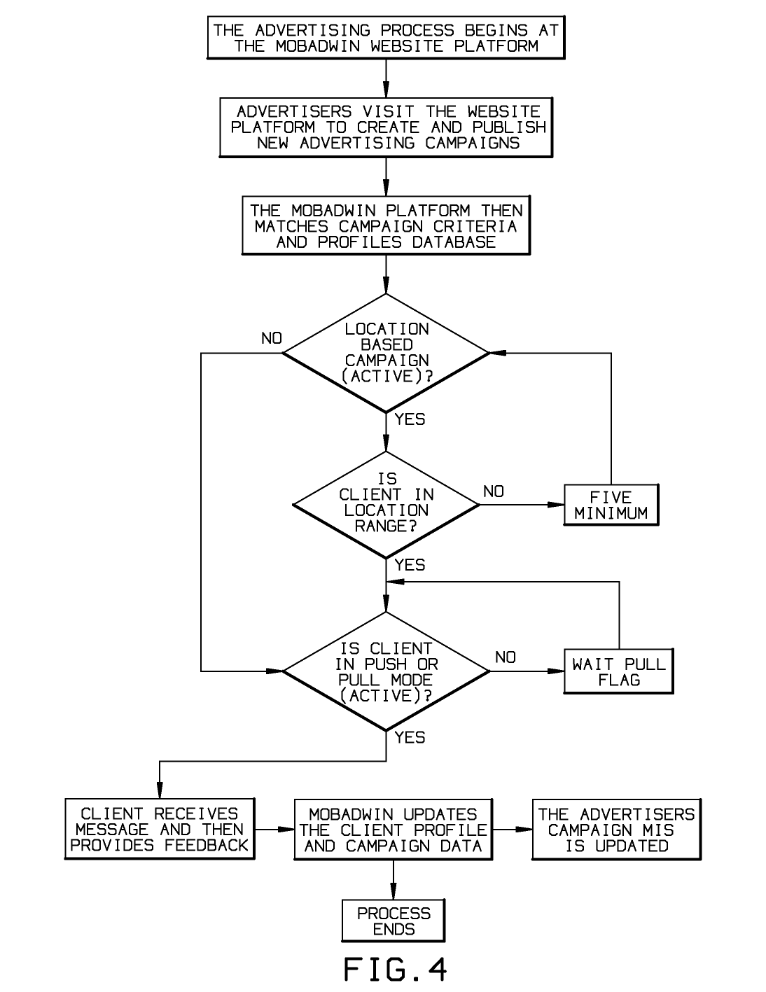

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

The Mobadwin™ process (according to one embodiment of the present invention) offers people the possibility to control their profile in a private and secure environment, to receive ads that interest them and to be paid for the time they will spend viewing and rating the advertisement.

The advertiser offers a positive image, creates an interactive relationship with the customer, obtains a real time feedback and market study as the campaign is unfolded, with the possibility to modify it, expand it, or shut it down, all the while being sure that money will only be spent on people who have willingly read and rated the ad. No money is wasted anymore. Finally, it is 100% electronic, therefore no more physical pollution.

The present invention solves the following problems in several ways. Traditional marketing and promotions method are a one-way street to passive receivers with no insurance that the promotion or ad will reach the proper audience. The receivers of advertisement are selected based upon a profile they build themselves, no more information gathered sneakily by websites and computer programs to build a consumer profile behind the back of the individual. The receiver of the ad can select what kind and how much advertisement he/she wishes to receive. The advertiser can modify its campaign at any time to fine tune it or correct mistakes, instead of campaigns that are fixed once they are launched on the air or on paper. The advertiser can modify the advertisement during the campaign to reach a better demographic/geographic based on a real-time feedback of how the ad is received by smartphone users. The advertiser only pays for the ads that are actually read, rated, and reviewed by the receiver. The advertiser can fine tune its budget to increase or decrease the scope of the campaign during the campaign, and either avoid unnecessary expenses, or capitalize on a successful promotion and expand it. The receiver of the advertisement is rewarded in real money, in addition to coupons, raffles, points to redeem, or any other promotional goody/gift that the advertiser decides to attach to its campaign.

This invention is an improvement on what currently exists. People still advertise like it's 1954 because the only options are the traditional media, whether or not they are internet flavored, like newspapers, billboards, tv, radio, mailing, pay-per-click, spam, listservs, or cold calling.

All this is shooting in the dark, expensive, slow, random, opaque and one way advertisement. The present solution offers a cheap, targeted, fast, transparent, and interactive platform that brings ads to willingly participating smartphone users who get rewarded with cash and coupons for the feedback they give.

Regular media advertisement like newspaper or radio are paid in advance, impossible to modify when launched, and only offer a very limited feedback. Internet advertisement is either intrusive or absolutely random. Its feedback is weak, and in the instance of pay-per-click, the advertiser has no control over the reality of the clicks. In the case of mass email, there is very little feedback and a lot ends up in the trash inbox or the spam inbox. Finally, internet promotions that offer deals if enough users buy them are extremely expensive, most often a loss for the advertiser, without offering a durable relationship with the customer. All these methods only offer feedback when the customer acts upon the ad received, but never a geographically and demographically detailed information on what kind of users dismiss the offer.

The Mobadwin™ process offers people the possibility to control their profile in a private and secure environment, to receive ads that interest them and to be paid for the time they will spend viewing and rating the advertisement. The advertiser offers a positive image, creates an interactive relationship with the customer, obtains a real time feedback and market study as the campaign is unfolded, with the possibility to modify it, expand it, or shut it down, all the while being sure that money will only be spent on people who have willingly read and rated the ad. No money is wasted anymore. Finally, it is 100% electronic, therefore no more physical pollution.

Also, the present invention can produce a very accurate real time reporting of the penetration of a marketing campaign, as well as the results of the market research attached to it, the cost and the return on investment.

### A Version of the Invention Discussed Here Includes:

1. a website platform on which the advertiser creates a campaign
2. a free smartphone application on which a user creates his own private consumer profile
3. a web-based back-office system that matches the ads with the smartphone users based on the criteria selected by the advertiser and the profile created by the smartphone user
4. a web-based back-office system that tracks in real time the penetration, feedback, redeeming of coupons, comments and reactions of the smartphone users for each campaign
5. a web-based back-office system that tracks the ads received by the smartphone users, the money and points they collect on their accounts, and sends them a prepaid debit card (or other gift or reward card) when they reach a multiple of $25 (or any other denomination) on their account
6. a web-based back-office system that tracks red flag behaviors from smartphone users in order to make sure that the person is not abusing the system
7. a smartphone-based system that enables the user to write a wishlist of goods and services he/she intends to acquire soon and match it with corresponding advertisement
8. a smartphone-based system that allows the user to use geo-localization processes in order to receive ads relevant to his profile when he gets in proximity of advertisers
9. a web-based back-office system that allows advertisers to pick a geographical point anywhere in the world and advertise in a chosen radius of this point to smartphone users who possess the application and have expressed interested in their types of goods and services
10. a smartphone-based system that allows application users to share a promotion or ad they have received with either other users of the app or members of their social networks or address book
11. a web-based back-office system that allows advertisers to ask specific questions to smartphone users either at the moment they read the ad, or after they have visited the business

### Relationship Between the Components:

A website platform 1 on which the advertiser creates a campaign using a simple wizard, allowing the possibility to choose the target audience based on several factors, such as demographics, geographics, income and centers of interest.

The website platforms uses a database of smartphone users, created through a free smartphone application 2 on which a user creates his own private consumer profile, requiring for completion that the user enters his coordinates and a series of demographic, geographic and interest related data.

The data collected is then linked to a web-based back-office system 3 that matches the ads created with website platform 1 with the smartphone users database created with smartphone application 2 based on the criteria selected by the advertiser and the profile created by the smartphone user, offering to the advertiser a web-based back-office system 4 that tracks in real time the penetration, feedback, redeeming of coupons, comments and reactions of the smartphone users for each campaign while a web-based back-office system 5 tracks the ads received by the smartphone users, the money and points they collect on their accounts and sends them a prepaid debit card when they reach a predetermined denomination of money on their account, unless a web-based back-office system 6 that tracks red flag behaviors from smartphone users in order to make sure that the person is not abusing the system gets activated, then the smartphone user is put on hold while being investigated.

In addition to smartphone application 2, a smartphone-based system 7 enables the user to write a wishlist of goods and services he/she intends to acquire soon and match it with corresponding advertisement whether or not the smartphone user enables a smartphone-based system 8 that allows the user to use geolocalisation processes in order to receive ads relevant to his profile when he gets in proximity of advertisers, or whether or not the advertiser uses a web-based back-office system 9 that allows advertisers to pick a geographical point anywhere in the world and advertise in a chosen radius of this point to smartphone users who possess the application and have expressed interested in their types of goods and services.

Further dissemination of the promotions and ads can be achieved with a smartphone-based system 10 that allows application users to share a promotion or ad they have received with other users of the app or members of their social networks or address book, as well as a web-based back-office system 11 that allows advertisers to ask specific questions to smartphone users either at the moment they read the ad, or after they have visited the business.

### How the Invention Works:

The internet part of the platform allows a business owner to create an account, then start a promotional campaign using a five step method. First step is naming the campaign and the campaign managers (people who will be able to access the data and modify them). Second step is to create a target audience, by picking demographic, geographic, and interest factors. Third step is to enter the text of the campaign, upload an image, text, or video. Fourth step is to enter the text image or video for the goodie/gift/coupon associated with the promo (if desired). Fifth step is to decide the budget and make payment.

The smartphone part of the platform allows a user to open an account, enter her/his profile by filling in the demographics, geographics and interest fields, then begin to receive advertisements on the app. If the ad is not rejected by the user, she/he can read it. If the user looks at it and answers the questions, the rating, and leave a comment (optional, to be determined by advertiser), then she/he receives money and experience points, as well as access to the gift/coupon/goodie that the advertiser can associate with the promo. The coupon has a limited duration that is set up by the advertiser. The user has the possibility to claim her/his money when a certain amount is reached, wait to get more on her/his, communicate the ads he likes with his social networks, reduce or augment the amount of ads received over a period of time, and change aspects of his profile.

### How to Make the Invention:

The present invention includes the core concept of rewarding the consumer for sharing feedback on advertisement sent to their smartphone based on a profile voluntarily given. Then, create the architecture of the three core elements: the application, the back-office system, and the management tools.

To create the application, the creator needs to think of all the aspects of a consumer profile that a potential advertiser may want to know, while balancing it with the aspect of a profile that the consumer is willing to give. Then create the relevant lists, and create the engine that will link the content of the app to the back office data base. In addition, a coupon/goodie redeeming system must be put in place, linking the promotion that the advertiser builds on the back office system to the “goodie redeeming tool” on the application, including a countdown system that destroys the goodie after usage. On top of that, the app must be fitted with a capacity to stream videos, link to the internet, dial a phone number, automatically update, use geo-localization tools, and more importantly keep the profile in sync with the database, providing the user with experience points when the profile gets more accurate.

Finally a system must be put in place to link, on a voluntary basis, the activity of the user to his/her social network connections, email, text messages and other means of communication available on a smartphone or a tablet. The Back office system must comprise first a system through which an advertiser builds its account and profile, selects its target audience, inputs its message and its promo material, inputs its coupons/perks and goodies, chooses the geographical scope of the advertisement campaign, sets a budget and process payment.

The management tool has two components, one is used by the advertiser, one is used by the company that owns the back office. The seller accesses the part of the management tool that will deliver in real time the feedbacks, penetration rate of the campaign, compare the campaign to equivalent campaigns in its industry and to its previous campaigns, reveal the comments left by end users, see the conversion rate of goodies with their time and demographics—all that to allow the possibility to fine tuning the campaign through an “edit campaign option.” The other part of the management tool, seen only by the owner of the back office, allows to trace the activity on all campaigns, and detect abuses, by using a system of red flags that include: duplicate names/addresses/phone numbers; systematic opening of all ads received; systematic identical rating of a majority of ads; no redeeming of coupons/goodies; no comments left; exaggerated similarities with other profiles; etc. If such red flags are raised, the system automatically reduces the flow of ads sent to that user and sends a message expressing concern about the red flag and asking the user to complete a better profile or play a fairer game. If no reaction is met, the user is shut down.

The present platform may be composed of two sides:

### Smartphone Based

Free Smartphone application (e.g., Android™ & iPhone iOS™) for customers.

Free web based back-office system for advertisers: to create and manage one's own campaigns.

Smartphone users voluntarily download the app and create their profile.

The user's data is NEVER shared with anybody including advertisers, Unlike Facebook™ and Google™, who pry on customers' privacy.

User selects the areas of interest for which he/she would like to receive ads.

The user receives selected ads matching his/her profile only when most convenient for him/her, with no spamming.

User can share his/her favorite ads on social networks (e.g., Facebook™, Twitter™, G+™) as well as by email.

The user provides feedback on the ad (a star-based rating, intention to act, free commenting). The free comment is confidential: only the advertiser sees it. This avoids unnecessary embarrassment for the advertiser.

The user may receive discounts, gifts, coupons with the ad. These goodies are at the discretion of the advertiser.

With each feedback, MobAdWin™ rewards the customer with cash. When the user has accumulated enough cash, the user receives a prepaid credit or debit card or other gift or account redemption card.

The user stacks experience points with each interaction (e.g., social network, feedbacks). Climbing steps, the user becomes eligible for special offers.

### Advertiser Web-Based Side (Back-Office)

The Advertiser uses the present Internet-based back-office system to create and manage campaigns.

Advertiser goes through a five-step wizard to create a campaign:

i) Assign a name to the campaign.
ii) Select the demographics (age, gender, location, etc.).
iii) Select the user's center of interest.
iv) Provide details onto the campaign such as: start/end dates, promo message, the maximum budget for this campaign, the location and localization based (the ads can be delivered when the user enters an X-miles radius from the spot) and goodies info (start/end date, message, associated media).
v) Add the campaign's media (text, image or a video) and post the campaign.

The advertiser tracks the campaign progress via the back-office application; live reports track all aspects of the campaign.

The Advertiser receives feedback from the customer base for accurately targeted campaigns that do not irritate the users and instead catch their immediate attention.

This is a success-based business: the advertiser is billed only upon received feedbacks. There are NO risks associated.

### Unique Value Proposition

Mobadwin™ does not offer publicity, it offers leads.

Advertiser pays on success only—no risk associated. There is a cap fixed by the advertiser per campaign and billing occurs on received feedbacks. If 5000 ads are sent but the advertiser receives only 250 feedbacks, the cost is only for the 250.

Unlike the Pay-per-Click method or similar, the cost is associated with the user's interaction; a click does not guarantee much, but a feedback/comment and the certainty that one's ad has been read offer much more.

Besides the powerful demographics segmentation, advertisers can now implement localization-based campaigns.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention.

What is claimed is:

1. A method of target advertising, comprising:
a) creating an advertisement;
b) selecting a target audience;
c) selecting a per-feedback reward;
d) selecting a budget;
e) sending the advertisement to members of the target audience;
f) receiving feedback from a subset of the members;
g) paying a reward to the subset based at least in part on the per-feedback reward; and
h) repeating steps e)-g) until reaching the budget.

2. The method as claimed in claim 1, wherein step e) comprises sending the advertisement to the members of the target audience via a wireless connection to mobile devices.

3. The method as claimed in claim 1, wherein step b) comprises selecting the target audience according to at least one of demographics, geographic location, and indicated interests.

4. The method as claimed in claim 1, wherein the feedback comprises at least one of a comment, a rating, and a purchase.

5. The method as claimed in claim 1, wherein step g) comprises paying the reward to the subset in the form of cards redeemable for at least one of goods, services, and cash.

6. The method as claimed in claim 1, further comprising tracking an advertisement campaign through an advertisement campaign analysis.

7. The method as claimed in claim 6, wherein the analysis comprises at least two of: a real-time feedback disclosure, a penetration rate, comparison of a current campaign to a prior campaign, and a conversion rate.

8. The method as claimed in claim 1, further comprising identifying abuse by abusive members of the target audience.

9. The method as claimed in claim 8, wherein the step of identifying abuse depends on at least one of: duplicate names, duplicate addresses, systematic opening of all advertisements received, and systematic identical rating of advertisements received.

10. A method of target advertising, comprising:
a) entering user information into a server;
b) providing a mobile device;
c) indicating a willingness to receive advertisements via the mobile device;
d) receiving advertisements wirelessly via the mobile device, the advertisements selected at least in part on the user information;
e) viewing the advertisements;
f) providing feedback regarding the advertisements; and
g) receiving a reward for providing the feedback.

11. The method as claimed in claim 10, further comprising sending at least one of the advertisements to others.

12. The method as claimed in claim 10, further comprising changing the user information after viewing the advertisements.

13. The method as claimed in claim 10, further comprising selecting a list of preferred rewards for providing feedback.

14. The method as claimed in claim 10, wherein the user information comprises at least one of demographics, geographic location, and indicated interests.

15. The method as claimed in claim 10, wherein the feedback comprises at least one of a comment, a rating, and a purchase.

16. The method as claimed in claim 10, wherein step g) comprises receiving the reward in the form of a card redeemable for at least one of goods, services, and cash.

17. The method as claimed in claim 10, wherein step g) comprises receiving the reward for providing the feedback only when a predetermined threshold has been reached.
